(19) United States
(12) Patent Application Publication
(10) Pub. No.: US 2025/0390529 A1
(43) Pub. Date: Dec. 25, 2025

(54) Querying User Feedback Sets

(71) Applicant: Samsung Electronics Co., Ltd., Suwon-si (KR)

(72) Inventors: Preeti Saraswat, Santa Clara, CA (US); Arvind Kulathu Ramachandran, Pleasanton, CA (US); Stephen Walsh, Sunnyvale, CA (US)

(21) Appl. No.: 19/063,962

(22) Filed: Feb. 26, 2025

Related U.S. Application Data
(60) Provisional application No. 63/663,601, filed on Jun. 24, 2024.

(51) Int. Cl. G06F 16/34; G06F 16/3329; G06F 16/334; G06F 16/338

(52) U.S. Cl. CPC G06F 16/345; G06F 16/3329; G06F 16/3347; G06F 16/338

(57) ABSTRACT

In one embodiment, a method includes accessing a set of user feedback, each user feedback in the set including natural-language feedback. The method further includes embedding each user feedback in the set into a vector embedding space; generating, by an LLM and based on the set of user feedback, a number of natural language summaries, each natural language summary corresponding to at least some of the user feedback in the set; and embedding each natural language summary in the vector embedding space. The method further includes receiving a query including a request for user-feedback information; embedding the query in the vector embedding space; and returning a query response that includes one or more natural-language summaries generated by an LLM, based on a similarity between the embedded query and one or more of (1) the embedded natural language summaries and (2) the embedded user feedback.

### PRIORITY CLAIM

This application claims the benefit under 35 U.S.C. § 119 of U.S. Provisional Patent Application No. 63/663,601 filed Jun. 24, 2024, which is incorporated by reference herein.

### TECHNICAL FIELD

This application generally relates to querying sets of user feedback.

### BACKGROUND

Users often provide feedback regarding products or services that they use. For example, a provider of consumer electronics (e.g., a smartphone, TV, etc.), an appliance (e.g., a toaster, an oven, a fridge, etc.), or a software application (e.g., a game, a messaging application, a productivity application, etc.) may obtain feedback from users of those products. The feedback may be either or both of external (e.g., may be made by users outside of the provider's organization) or internal (e.g., may be made by users, such as employees, within the provider's organization). Feedback can be solicited, in that the provider or an agent of the provider may seek feedback directly from users or encourage users to provide feedback regarding a product or service. Feedback may also be provided on users' own initiative, for example if a user navigates to a feedback interface and provides feedback.

### BRIEF DESCRIPTION OF THE DRAWING

FIG. 1 illustrates an example method of facilitating queries on user feedback data.

FIG. 2 illustrates an example diagram implementing certain aspects of the method of FIG. 1, among other things.

FIG. 3 illustrates an example computing system.

### DESCRIPTION OF EXAMPLE EMBODIMENTS

User-feedback data plays an important role in shaping product development and enhancing user experiences with products and services, including electronic devices, applications, and services such as voice assistants and AI agents. However, the volume of user feedback a provider receives can be huge and may include hundreds, thousands, or even more instances of user feedback received on a product or service each day, and this challenge can be particularly acute with products or services that have millions of users and therefore receive very large amounts of feedback. Conventional approaches of, for example, reading or annotating user feedback data do not work when large amounts of feedback are present.

One significant challenge is generating real-time insights from large-scale user feedback data. Conventional approaches that use SQL queries on large databases typically do not operate in real-time (i.e., in a matter of seconds or a few minutes), and therefore impede gaining insight from user feedback. Reducing the amount of feedback data by relying on summaries or samplings of the data, however, can introduce inaccuracy because synthesized insights alone don't suffice. A robust analysis of user feedback instead should include source feedback data, for example to avoid hallucinated insights generated by AI models.

In addition, conventional SQL queries and filters are limited in nature to the filters and database fields that are available, and therefore do not permit more specific or fuller exploration of the feedback data.

The techniques of this disclose address those problems and allow for real-time exploration of large sets of user feedback, while offering insights that are based on actual feedback instances and are not limited to summaries or sampling. In addition, the techniques described herein allow for natural-language exploration of user feedback sets, resulting in more detailed and particularized analysis of the feedback. As a result, better identification and understanding of user feedback improves the development and improvement of products and services.

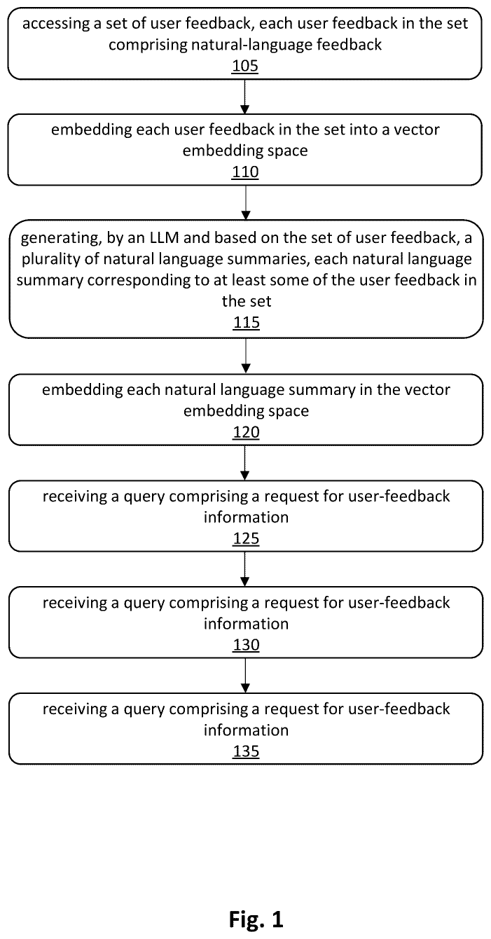

FIG. 1 illustrates an example method of facilitating queries on user feedback data. Step 105 of the example method of FIG. 1 includes accessing a set of user feedback, where each user feedback in the set includes some natural-language feedback. In particular embodiments, the user feedback may include additional feedback, such as numerical identifiers (e.g., rating a product or feature from 1-5), more binary impressions (e.g., thumbs up or thumbs down), or emojis indicating like or dislike of a product or service. In particular embodiments, user feedback may include metadata, such as a time in which the user feedback was provided, a device from which the user feedback was received, a geographic region from which the user feedback was received, etc. In particular embodiments, this metadata may be used to help refine subsequent queries on user feedback. For instance, a query may consider user feedback over a particular time period.

In particular embodiments, step 105 is performed periodically, e.g., each day, week, or month, etc. Shorter time frames may be particularly suitable for products or services that are used by many users, and therefore generate substantial amounts of feedback. In particular embodiments, step 105 may be repeated based on a product or service's iterations or lifecycle, e.g., may be repeated each time a new product version is released, so that feedback can be parsed according to particular product versions.

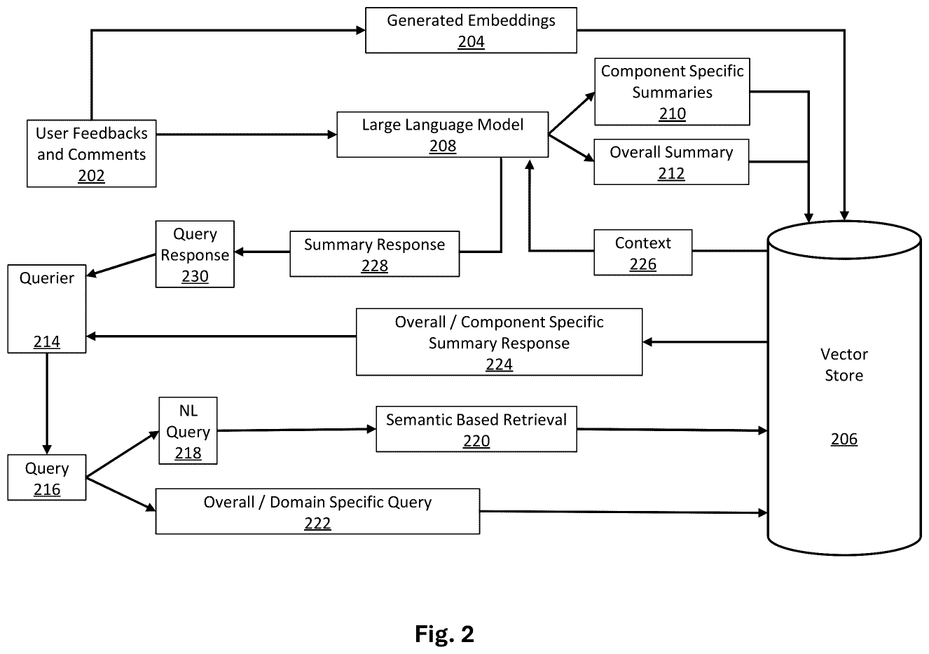

FIG. 2 illustrates an example diagram implementing aspects of the example method of FIG. 1, among other things. In the example of FIG. 2, user feedback 202 corresponds to the set of user feedback reference in step 105.

Step 110 of the example method of FIG. 1 includes embedding each user feedback in the set into a vector embedding space. FIG. 2 illustrates an example in which each user feedback in set 202 is generated in step 204, and these feedback-specific embeddings are then stored in a vector store (or database) 206. In particular embodiments, additional data may be stored in association with each embedding, either in vector store 206 or in another data store. For example, the embedding vector (i.e., the vector's values for each relevant dimension in the embedding space) may be stored along with a feedback ID identifying the feedback and the feedback itself. While the example method of FIG. 1 and the example diagram of FIG. 2 illustrate embedding each user feedback, particular embodiments may not use this step, for example in order to reduce the compute time and storage resources associated with embedding and storing each feedback. In particular embodiments, vector store 206 may include only the embeddings of the set of user feedback 202. In other embodiments, these embeddings may be added to vector store 206, such that vector store 206 includes embeddings from previous sets of user feedback.

Step 115 includes generating, by an LLM and based on the set of user feedback, a number of natural language summaries, each natural language summary corresponding to at least some of the user feedback in the set. The example of FIG. 2 illustrates how user feedback 202 is passed to LLM 208, which provides one or both of two kinds of summaries: (1) component-specific summaries 210 and (2) overall summaries 212. Along with user feedback 202, a prompt is provided to LLM 208 instructing the LLM to generate the summaries. For instance, the prompt may instruct the LLM to identify patterns in the user feedback (e.g., the (relative or absolute) frequencies at which certain issues occur or at which certain features receive praise), and then to incorporate identified patterns (or the most meaningful subset of them) into the generated summaries. In particular embodiments, feedback summaries are limited to a specific timeframe corresponding to the timeframe associated with user feedback 202, as described above.

Overall summaries 212 relate to the set of entire user feedback 202, and more than one such summary may be generated. For instance, an overall summary for a voice assistant may identify the most frequently occurring problems or the most frustrating problems, and/or may identify the most positively received features and/or the most requested changes or new features. Component-specific summaries (also referred to as domain-specific summaries) 210 each apply to a particular predefined domain within the overall product or service being reviewed. For instance, user feedback for a voice assistant may be divided into domains or components including account creation, language recognition, responsiveness, accuracy, natural-language output, and integration with other services (e.g., with a music-playing service, with smart device, etc.). Feedback from set 202 corresponding to each of these domains is determined by LLM 208 (based on, e.g., domains identified in the prompt provided to the LLM), and then one or more domain-specific summaries for each domain is generated by the LLM.

Step 120 of the example method of FIG. 1 includes embedding each natural language summary in the vector embedding space. FIG. 2 illustrates that summaries 210 and 212 are embedded and then stored in vector store 206, which also contains the embeddings generated directly from the user feedback 202. In particular embodiment, the embedding of user feedback and the generation and embedding of summaries may occur in parallel. As described above with respect to embeddings of user feedback, in particular embodiments additional data may be associated with each summary embedding, such as an embedding ID and the respective natural-language summary itself.

Step 125 of the example method of FIG. 1 includes receiving a query that includes a request for user-feedback information. The query may be generated by, for example, a data scientist associated with the provider of the product or service. In the example of FIG. 2, query 216 is generated by querier 214, for example using a UI designed to query the user feedback.

FIG. 2 illustrates two types of queries, which are not mutually exclusive. Domain-specific queries or overall queries 222 are generated using predefined query values, such as predefined filters that correspond to the predefined domains. For instance, a querier may generate a query 222 that seeks all feedback related to installation of version 1.3 of a particular software update for a product. Such queries, as with NLU queries 218, may also include other constraints, such as a particular timeframe the querier is interested in.

Queries 218 are natural-language (NL) queries in which the query describes the information they are looking for using natural language. For instance, a query may say “give me the user feedback regarding problems with integrating a voice assistant with a SOFTWARE_NAME”, where SOFTWARE_NAME identifies, for instance, a particular music-paying application.

Step 130 of the example method of FIG. 1 includes embedding the query in the vector embedding space. Here, the same embedding process and vector embedding space used to embed the user feedback (if such embedding is performed) and used to embed the LLM-generated summaries is also used to embed the query.

Step 135 of the example method of FIG. 1 includes returning a query response that includes one or more natural-language summaries generated by an LLM, based on a similarity between the embedded query and one or more of (1) the embedded natural language summaries or (2) the embedded user feedback. In other words, the query response includes at least one of the summaries generated by LLM 208 in step 120, although as explained below, the query response may include additional information as well.

For a query 222, the query is embedded and relevant natural-language summaries are identified based on a similarity, such as a distance, between the query's embedding and the embeddings of the natural-language summaries. Relevance may be determined based on a threshold similarity value (e.g., at least 70% similar, although other threshold values may be used). In particular embodiments, similarity between the query and particular instances of user feedback may also be determined, and the most relevant user feedback instances may be returned as part of the query response 224.

When a query includes an NL query 218, then semantic based retrieval 218 is used to determine which content in vector store 206 is relevant to the query, e.g., by embedding the query and determining relevance based on a similarity between the embedded query and the embedded natural-language summaries and/or embedded particular instances of user feedback in vector store 206. As illustrated in FIG. 2, the relevant content (e.g., the actual natural-language summaries and/or the actual instance of user feedback) identified from the vector store may then be passed to an LLM, such as LLM 208 (but may be a different LLM, in particular embodiments), as context 226 along with the query and a prompt instructing the LLM to answer the user's query. If the LLM determines that it can answer the query based on the context, then the LLM generates a summary response 228 to the query. Summary response 228 and, in particular embodiments, the underlying natural-language response summaries and/or instance of user feedback previously determined to be relevant to the query may be provided as a query response 230 to query 214. For instance, summary response 228 may be immediately surfaced to the querier, while specific instance of relevant user feedback may be provided on demand, at the querier's request.

If the LLM determines that it cannot answer the query, then the LLM may inform the user that the requested data is not available or that it cannot answer the query with the available data.

In particular embodiments, user feedback and/or LLM-generated summaries may be automatically analyzed, e.g., by an AI agent, to identify patterns and issues corresponding to the feedback. The identified issues may be automatically surfaced to a user (e.g., a data scientist) of the feedback system, notifying the user in advance of areas for improvement or further development based on the user feedback received.

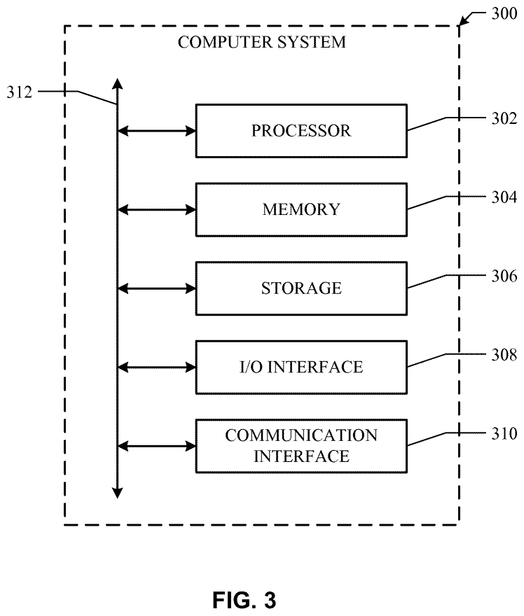

FIG. 3 illustrates an example computer system 300. In particular embodiments, one or more computer systems 300 perform one or more steps of one or more methods described or illustrated herein. In particular embodiments, one or more computer systems 300 provide functionality described or illustrated herein. In particular embodiments, software running on one or more computer systems 300 performs one or more steps of one or more methods described or illustrated herein or provides functionality described or illustrated herein. Particular embodiments include one or more portions of one or more computer systems 300. Herein, reference to a computer system may encompass a computing device, and vice versa, where appropriate. Moreover, reference to a computer system may encompass one or more computer systems, where appropriate.

This disclosure contemplates any suitable number of computer systems 300. This disclosure contemplates computer system 300 taking any suitable physical form. As example and not by way of limitation, computer system 300 may be an embedded computer system, a system-on-chip (SOC), a single-board computer system (SBC) (such as, for example, a computer-on-module (COM) or system-on-module (SOM)), a desktop computer system, a laptop or notebook computer system, an interactive kiosk, a mainframe, a mesh of computer systems, a mobile telephone, a personal digital assistant (PDA), a server, a tablet computer system, or a combination of two or more of these. Where appropriate, computer system 300 may include one or more computer systems 300; be unitary or distributed; span multiple locations; span multiple machines; span multiple data centers; or reside in a cloud, which may include one or more cloud components in one or more networks. Where appropriate, one or more computer systems 300 may perform without substantial spatial or temporal limitation one or more steps of one or more methods described or illustrated herein. As an example and not by way of limitation, one or more computer systems 300 may perform in real time or in batch mode one or more steps of one or more methods described or illustrated herein. One or more computer systems 300 may perform at different times or at different locations one or more steps of one or more methods described or illustrated herein, where appropriate.

In particular embodiments, computer system 300 includes a processor 302, memory 304, storage 306, an input/output (I/O) interface 308, a communication interface 310, and a bus 312. Although this disclosure describes and illustrates a particular computer system having a particular number of particular components in a particular arrangement, this disclosure contemplates any suitable computer system having any suitable number of any suitable components in any suitable arrangement.

In particular embodiments, processor 302 includes hardware for executing instructions, such as those making up a computer program. As an example and not by way of limitation, to execute instructions, processor 302 may retrieve (or fetch) the instructions from an internal register, an internal cache, memory 304, or storage 306; decode and execute them; and then write one or more results to an internal register, an internal cache, memory 304, or storage 306. In particular embodiments, processor 302 may include one or more internal caches for data, instructions, or addresses. This disclosure contemplates processor 302 including any suitable number of any suitable internal caches, where appropriate. As an example and not by way of limitation, processor 302 may include one or more instruction caches, one or more data caches, and one or more translation lookaside buffers (TLBs). Instructions in the instruction caches may be copies of instructions in memory 304 or storage 306, and the instruction caches may speed up retrieval of those instructions by processor 302. Data in the data caches may be copies of data in memory 304 or storage 306 for instructions executing at processor 302 to operate on; the results of previous instructions executed at processor 302 for access by subsequent instructions executing at processor 302 or for writing to memory 304 or storage 306; or other suitable data. The data caches may speed up read or write operations by processor 302. The TLBs may speed up virtual-address translation for processor 302. In particular embodiments, processor 302 may include one or more internal registers for data, instructions, or addresses. This disclosure contemplates processor 302 including any suitable number of any suitable internal registers, where appropriate. Where appropriate, processor 302 may include one or more arithmetic logic units (ALUs); be a multi-core processor; or include one or more processors 302. Although this disclosure describes and illustrates a particular processor, this disclosure contemplates any suitable processor.

In particular embodiments, memory 304 includes main memory for storing instructions for processor 302 to execute or data for processor 302 to operate on. As an example and not by way of limitation, computer system 300 may load instructions from storage 306 or another source (such as, for example, another computer system 300) to memory 304. Processor 302 may then load the instructions from memory 304 to an internal register or internal cache. To execute the instructions, processor 302 may retrieve the instructions from the internal register or internal cache and decode them. During or after execution of the instructions, processor 302 may write one or more results (which may be intermediate or final results) to the internal register or internal cache. Processor 302 may then write one or more of those results to memory 304. In particular embodiments, processor 302 executes only instructions in one or more internal registers or internal caches or in memory 304 (as opposed to storage 306 or elsewhere) and operates only on data in one or more internal registers or internal caches or in memory 304 (as opposed to storage 306 or elsewhere). One or more memory buses (which may each include an address bus and a data bus) may couple processor 302 to memory 304. Bus 312 may include one or more memory buses, as described below. In particular embodiments, one or more memory management units (MMUs) reside between processor 302 and memory 304 and facilitate accesses to memory 304 requested by processor 302. In particular embodiments, memory 304 includes random access memory (RAM). This RAM may be volatile memory, where appropriate Where appropriate, this RAM may be dynamic RAM (DRAM) or static RAM (SRAM). Moreover, where appropriate, this RAM may be single-ported or multi-ported RAM. This disclosure contemplates any suitable RAM. Memory 304 may include one or more memories 304, where appropriate. Although this disclosure describes and illustrates particular memory, this disclosure contemplates any suitable memory.

In particular embodiments, storage 306 includes mass storage for data or instructions. As an example and not by way of limitation, storage 306 may include a hard disk drive (HDD), a floppy disk drive, flash memory, an optical disc, a magneto-optical disc, magnetic tape, or a Universal Serial Bus (USB) drive or a combination of two or more of these. Storage 306 may include removable or non-removable (or fixed) media, where appropriate. Storage 306 may be internal or external to computer system 300, where appropriate. In particular embodiments, storage 306 is non-volatile, solid-state memory. In particular embodiments, storage 306 includes read-only memory (ROM). Where appropriate, this ROM may be mask-programmed ROM, programmable ROM (PROM), erasable PROM (EPROM), electrically erasable PROM (EEPROM), electrically alterable ROM (EAROM), or flash memory or a combination of two or more of these. This disclosure contemplates mass storage 306 taking any suitable physical form. Storage 306 may include one or more storage control units facilitating communication between processor 302 and storage 306, where appropriate. Where appropriate, storage 306 may include one or more storages 306. Although this disclosure describes and illustrates particular storage, this disclosure contemplates any suitable storage.

In particular embodiments, I/O interface 308 includes hardware, software, or both, providing one or more interfaces for communication between computer system 300 and one or more I/O devices. Computer system 300 may include one or more of these I/O devices, where appropriate. One or more of these I/O devices may enable communication between a person and computer system 300. As an example and not by way of limitation, an I/O device may include a keyboard, keypad, microphone, monitor, mouse, printer, scanner, speaker, still camera, stylus, tablet, touch screen, trackball, video camera, another suitable I/O device or a combination of two or more of these. An I/O device may include one or more sensors. This disclosure contemplates any suitable I/O devices and any suitable I/O interfaces 308 for them. Where appropriate, I/O interface 308 may include one or more device or software drivers enabling processor 302 to drive one or more of these I/O devices. I/O interface 308 may include one or more I/O interfaces 308, where appropriate. Although this disclosure describes and illustrates a particular I/O interface, this disclosure contemplates any suitable I/O interface.

In particular embodiments, communication interface 310 includes hardware, software, or both providing one or more interfaces for communication (such as, for example, packet-based communication) between computer system 300 and one or more other computer systems 300 or one or more networks. As an example and not by way of limitation, communication interface 310 may include a network interface controller (NIC) or network adapter for communicating with an Ethernet or other wire-based network or a wireless NIC (WNIC) or wireless adapter for communicating with a wireless network, such as a WI-FI network. This disclosure contemplates any suitable network and any suitable communication interface 310 for it. As an example and not by way of limitation, computer system 300 may communicate with an ad hoc network, a personal area network (PAN), a local area network (LAN), a wide area network (WAN), a metropolitan area network (MAN), or one or more portions of the Internet or a combination of two or more of these. One or more portions of one or more of these networks may be wired or wireless. As an example, computer system 300 may communicate with a wireless PAN (WPAN) (such as, for example, a BLUETOOTH WPAN), a WI-FI network, a WI-MAX network, a cellular telephone network (such as, for example, a Global System for Mobile Communications (GSM) network), or other suitable wireless network or a combination of two or more of these. Computer system 300 may include any suitable communication interface 310 for any of these networks, where appropriate. Communication interface 310 may include one or more communication interfaces 310, where appropriate. Although this disclosure describes and illustrates a particular communication interface, this disclosure contemplates any suitable communication interface.

In particular embodiments, bus 312 includes hardware, software, or both coupling components of computer system 300 to each other. As an example and not by way of limitation, bus 312 may include an Accelerated Graphics Port (AGP) or other graphics bus, an Enhanced Industry Standard Architecture (EISA) bus, a front-side bus (FSB), a HYPERTRANSPORT (HT) interconnect, an Industry Standard Architecture (ISA) bus, an INFINIBAND interconnect, a low-pin-count (LPC) bus, a memory bus, a Micro Channel Architecture (MCA) bus, a Peripheral Component Interconnect (PCI) bus, a PCI-Express (PCIe) bus, a serial advanced technology attachment (SATA) bus, a Video Electronics Standards Association local (VLB) bus, or another suitable bus or a combination of two or more of these. Bus 312 may include one or more buses 312, where appropriate. Although this disclosure describes and illustrates a particular bus, this disclosure contemplates any suitable bus or interconnect.

Herein, a computer-readable non-transitory storage medium or media may include one or more semiconductor-based or other integrated circuits (ICs) (such, as for example, field-programmable gate arrays (FPGAs) or application-specific ICs (ASICs)), hard disk drives (HDDs), hybrid hard drives (HHDs), optical discs, optical disc drives (ODDs), magneto-optical discs, magneto-optical drives, floppy diskettes, floppy disk drives (FDDs), magnetic tapes, solid-state drives (SSDs), RAM-drives, SECURE DIGITAL cards or drives, any other suitable computer-readable non-transitory storage media, or any suitable combination of two or more of these, where appropriate. A computer-readable non-transitory storage medium may be volatile, non-volatile, or a combination of volatile and non-volatile, where appropriate.

Herein, “or” is inclusive and not exclusive, unless expressly indicated otherwise or indicated otherwise by context. Therefore, herein, “A or B” means “A, B, or both,” unless expressly indicated otherwise or indicated otherwise by context. Moreover, “and” is both joint and several, unless expressly indicated otherwise or indicated otherwise by context. Therefore, herein, “A and B” means “A and B, jointly or severally,” unless expressly indicated otherwise or indicated otherwise by context.

The scope of this disclosure encompasses all changes, substitutions, variations, alterations, and modifications to the example embodiments described or illustrated herein that a person having ordinary skill in the art would comprehend. The scope of this disclosure is not limited to the example embodiments described or illustrated herein. Moreover, although this disclosure describes and illustrates respective embodiments herein as including particular components, elements, feature, functions, operations, or steps, any of these embodiments may include any combination or permutation of any of the components, elements, features, functions, operations, or steps described or illustrated anywhere herein that a person having ordinary skill in the art would comprehend.

What is claimed is:

1. A method comprising:
accessing a set of user feedback, each user feedback in the set comprising natural-language feedback;
embedding each user feedback in the set into a vector embedding space;
generating, by an LLM and based on the set of user feedback, a plurality of natural language summaries, each natural language summary corresponding to at least some of the user feedback in the set;
embedding each natural language summary in the vector embedding space;
receiving a query comprising a request for user-feedback information;
embedding the query in the vector embedding space; and
returning a query response comprising one or more natural-language summaries generated by an LLM, based on a similarity between the embedded query and one or more of (1) the embedded natural language summaries or (2) the embedded user feedback.

2. The method of claim 1, wherein the query comprises a set of pre-defined query filters.

3. The method of claim 1, wherein the query comprises a natural-language query.

4. The method of claim 3, further comprising:
determining, based on the embedded natural-language query, one or more relevant natural-language summaries having a query relevance that exceeds a relevancy threshold;
generating, by an LLM and based (1) the query and (2) the relevant natural-language summaries, a summary response to the query; and
returning the generated summary response as part of the query response.

5. The method of claim 4, further comprising:
determining, based on the embedded natural-language query, one or more relevant user feedbacks having a query relevance that exceeds a relevancy threshold;
generating, by the LLM and based (1) the query (2) the relevant natural-language summaries and (3) the one or more relevant user feedbacks, the summary response to the query; and
returning the generated summary response and the one or more relevant user feedbacks as part of the query response.

6. The method of claim 1, wherein the generated natural language summaries comprise (1) one or more overall summaries directed to the entire set of user feedback and (2) one or more domain-specific summaries, each directed to a particular pre-defined domain.

7. The method of claim 1, wherein each user feedback in the set corresponds to a particular predefined timeframe.

8. The method of claim 7, wherein the vector embedding space includes embeddings of one or more sets of user feedback corresponding to one or more different predefined timeframes.

9. One or more non-transitory computer readable storage media storing instructions that are operable when executed to:
access a set of user feedback, each user feedback in the set comprising natural-language feedback;
embed each user feedback in the set into a vector embedding space;
generate, by an LLM and based on the set of user feedback, a plurality of natural language summaries, each natural language summary corresponding to at least some of the user feedback in the set;
embed each natural language summary in the vector embedding space;
access a query comprising a request for user-feedback information;
embed the query in the vector embedding space; and
return a query response comprising one or more natural-language summaries generated by an LLM, based on a similarity between the embedded query and one or more of (1) the embedded natural language summaries or (2) the embedded user feedback.

10. The media of claim 9, wherein the query comprises a set of pre-defined query filters.

11. The media of claim 9, wherein the query comprises a natural-language query.

12. The media of claim 11, wherein the instructions are further operable when executed to:
determining, based on the embedded natural-language query, one or more relevant natural-language summaries having a query relevance that exceeds a relevancy threshold;
generating, by an LLM and based (1) the query and (2) the relevant natural-language summaries, a summary response to the query; and
returning the generated summary response as part of the query response.

13. The media of claim 12, wherein the instructions are further operable when executed to:
determining, based on the embedded natural-language query, one or more relevant user feedbacks having a query relevance that exceeds a relevancy threshold;
generating, by the LLM and based (1) the query (2) the relevant natural-language summaries and (3) the one or more relevant user feedbacks, the summary response to the query; and
returning the generated summary response and the one or more relevant user feedbacks as part of the query response.

14. The media of claim 9, wherein the generated natural language summaries comprise (1) one or more overall summaries directed to the entire set of user feedback and (2) one or more domain-specific summaries, each directed to a particular pre-defined domain.

15. A system comprising:
one or more non-transitory computer readable storage media storing instructions; and one or more processors coupled to the one or more non-transitory computer readable storage media and operable to execute the instructions to:
access a set of user feedback, each user feedback in the set comprising natural-language feedback;
embed each user feedback in the set into a vector embedding space;
generate, by an LLM and based on the set of user feedback, a plurality of natural language summaries, each natural language summary corresponding to at least some of the user feedback in the set;
embed each natural language summary in the vector embedding space;
access a query comprising a request for user-feedback information;
embed the query in the vector embedding space; and
return a query response comprising one or more natural-language summaries generated by an LLM, based on a similarity between the embedded query and one or more of (1) the embedded natural language summaries or (2) the embedded user feedback.

16. The system of claim 15, wherein the query comprises a set of pre-defined query filters.

17. The system of claim 15, wherein the query comprises a natural-language query.

18. The system of claim 17, further comprising one or more processors that are operable to execute the instructions to:
determining, based on the embedded natural-language query, one or more relevant natural-language summaries having a query relevance that exceeds a relevancy threshold;
generating, by an LLM and based (1) the query and (2) the relevant natural-language summaries, a summary response to the query; and
returning the generated summary response as part of the query response.

19. The system of claim 18, further comprising one or more processors that are operable to execute the instructions to:
determining, based on the embedded natural-language query, one or more relevant user feedbacks having a query relevance that exceeds a relevancy threshold;
generating, by the LLM and based (1) the query (2) the relevant natural-language summaries and (3) the one or more relevant user feedbacks, the summary response to the query; and
returning the generated summary response and the one or more relevant user feedbacks as part of the query response.

20. The system of claim 15, wherein the generated natural language summaries comprise (1) one or more overall summaries directed to the entire set of user feedback and (2) one or more domain-specific summaries, each directed to a particular pre-defined domain.
